(19) United States
(12) Patent Application Publication
(10) Pub. No.: US 2018/0258315 A1
(43) Pub. Date: Sep. 13, 2018

(54) TWO-COMPONENT COATING COMPOUNDS

(71) Applicant: BASF SE, Ludwigshafen am Rhein (DE)

(72) Inventors: Sebastian ROLLER, Mannheim (DE); Ulrich TROMSDORF, Heidelberg (DE); Rabie Al-HELLANI, Ludwigshafen (DE); Frederic LUCAS, Ludwigshafen am Rhein (DE); Stefan KIRSCH, Nieder-Olm (DE)

(73) Assignee: BASF SE, Ludwigshafen am Rhein (DE)

(21) Appl. No.: 15/762,253

(22) PCT Filed: Sep. 19, 2016
(86) PCT No.: PCT/EP2016/072096

§ 371 Date: Mar. 22, 2018

(30) Foreign Application Priority Data
Sep. 23, 2015 (EP) 15186524.3

(51) Int. Cl. C09D 175/14; C09D 5/02

(52) U.S. Cl. CPC C09D 175/14; C08G 18/7837; C09D 5/024

(57) ABSTRACT

Two-component coating compositions comprising
a water-dispersible polyisocyanate component, comprising
c) at least one polyisocyanate and
d) at least one reaction product of at least one polyisocyanate b1) with compounds b2) having at least one hydrophilic, non-isocyanate-reactive group (group A) and at least one isocyanate-reactive group (group B)
and
a polyacrylate component comprising
   an aqueous polymer dispersion c) of at least one hydroxy-functional poly(meth)acrylate with bimodal or polymodal particle size distribution.

The present invention relates to two-component coating compositions which comprise a water-emulsifiable polyisocyanate component, comprising
a) at least one polyisocyanate and
b) at least one reaction product of at least one polyisocyanate b1) with compounds b2) having at least one hydrophilic, non-isocyanate-reactive group (group A) and at least one isocyanate-reactive group (group B)
and a
polyacrylate component comprising
an aqueous polymer dispersion c) of at least one hydroxy-functional poly(meth)acrylate with bimodal or polymodal particle size distribution,
and also to methods for production thereof and use thereof.

Bimodal or polymodal in respect of the bimodal or polymodal particle size distribution should be understood to mean that the aqueous polymer dispersion c) contains particles having at least two different maxima, separated from one another, in their particle size distribution curve (or particles grouped around at least two different maxima, separated from one another, in its particle size distribution curve) (wt % or intensity=ordinate or y-axis, size=abscissa or x-axis), whereas monomodal in relation to the aqueous polymer dispersion c) means that the aqueous polymer dispersion c) contains particles having a single maximum in their particle size distribution curve (or particles grouped around a single maximum in its particle size distribution curve). Weight-average particle size (Dw) should be understood to mean the diameter of the particle, since in general the particles are substantially spherical and are considered for practical purposes to be preferably spherical.

Water-emulsifiable polyisocyanate components are added to aqueous polymer dispersions, as crosslinking agents, and are widely described in the literature. Emulsifiability in water is achieved by reacting some of the isocyanate groups in the polyisocyanates with hydrophilic compounds, or blending polyisocyanates hydrophilically modified in this way with conventional polyisocyanates.

WO 91/384112 A1 discloses polymer dispersions having at least bimodal particle size distribution. In the description, alongside numerous other modifications, there is also mention of the possibility of hydroxyl functionalization. Moreover, there is also an indication of the possibility of a reaction with polyisocyanates, as one of many. Advantages of these polymer dispersions in two-component systems, in respect of viscosity and film properties, are not described.

U.S. Pat. No. 5,744,544 describes bimodal or multimodal dispersions for achieving very high solids contents, in which at least one particle size population has a diameter >1 μm. Properties of these polymer dispersions in two-component systems are not described.

It was an object of the present invention to provide two-component coating compositions which exhibit advantages in respect of viscosity, drying, the behavior of the (polyisocyanate) crosslinking agent on incorporation by stirring, and the film appearance/gloss.

Found accordingly have been the above-defined two-component coating compositions, the use thereof in coating materials and paints, and a method for producing them.

The two-component coating compositions comprise a polyisocyanate component and a polyacrylate component.

The water-emulsifiable polyisocyanate component comprises at least one polyisocyanate as component a).

At least one polyisocyanate means one polyisocyanate or a mixture of two or more polyisocyanates with different compositions, preference being given to one polyisocyanate. It will be understood that the expression “one polyisocyanate” likewise embraces a mixture of polyisocyanates which differ merely in their chain length and/or in the arrangement of the monomers within the polymer chain.

The at least one polyisocyanate can be prepared by polymerization of monomeric aromatic, aliphatic and/or cycloaliphatic isocyanates, preferably of aliphatic and/or cycloaliphatic (in this text referred to as (cyclo)aliphatic for short) isocyanates and particularly preferably of aliphatic isocyanates.

Aromatic isocyanates are isocyanates which comprise at least one aromatic ring system, i.e. either purely aromatic compounds or araliphatic compounds. The former are isocyanates in which the isocyanato groups are bound directly to aromatic ring systems, while in the case of the latter the isocyanato groups are bound to alkylene groups but the compounds also comprise aromatic ring systems, as is the case, for example, in α,α,α′,α′-tetramethylxylylene 1,3-diisocyanate (TMXDI).

Cycloaliphatic isocyanates are ones which comprise at least one cycloaliphatic ring system. Aliphatic isocyanates are ones which comprise exclusively linear or branched carbon chains, i.e. acyclic compounds.

The monomeric aromatic, aliphatic and/or cycloaliphatic isocyanates can in each case be identical or different isocyanates.

The monomeric aromatic, aliphatic and/or cycloaliphatic isocyanates are preferably diisocyanates, which bear precisely two isocyanate groups. However, they can in principle also be monoisocyanates, having one isocyanate group.

Higher isocyanates having an average of more than two isocyanate groups are also possible in principle. Examples of suitable compounds of this type are triisocyanates such as triisocyanatononane, 2′-isocyanatoethyl 2,6-diisocyanatohexanoate, 2,4,6-triisocyanatotoluene, triphenylmethane triisocyanate or 2,4,4′-triisocyanato(diphenyl ether) or the mixtures of diisocyanates, triisocyanates and higher polyisocyanates.

The monomeric aromatic, aliphatic and/or cycloaliphatic isocyanates have no significant reaction products of the isocyanate groups with themselves.

The monomeric aromatic, aliphatic and/or cycloaliphatic isocyanates are preferably isocyanates having from 4 to 20 carbon atoms. Examples of customary diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate (e.g. methyl or ethyl 2,6-diisocyanatohexanoate), trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)-methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane and also 3- (or 4-), 8- (or 9-)bis(isocyanatomethyl)tricyclo[5.2.1.02.6]decane isomer mixtures, and also aromatic diisocyanates such as tolylene 2,4- or 2,6-diisocyanate and isomer mixtures thereof, m- or p-xylylene diisocyanate, 2,4′- or 4,4′-diisocyanatodiphenyl-methane and isomer mixtures thereof, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Particular preference is given to hexamethylene 1,6-diisocyanate, 1,3-bis(isocyanatomethyl)-cyclohexane, isophorone diisocyanate and 4,4′- or 2,4′-di(isocyanatocyclohexyl)methane, with very particular preference being given to isophorone diisocyanate and hexamethylene 1,6-diisocyanate, in particular hexamethylene 1,6-diisocyanate.

Mixtures of the isocyanates mentioned can also be present.

Isophorone diisocyanate is usually present as a mixture, namely of the cis and trans isomers, generally in a ratio of from about 60:40 to 90:10 (w/w), preferably from 70:30 to 90:10.

Dicyclohexylmethane 4,4′-diisocyanate can likewise be present as a mixture of the various cis and trans isomers.

As diisocyanates, it is possible to use both diisocyanates which are obtained by phosgenation of the corresponding amines and also those which are prepared without the use of phosgene, i.e. by phosgene-free processes. For example, according to EP-A-126 299 (U.S. Pat. No. 4,596,678), EP-A-126 300 (U.S. Pat. No. 4,596,679) and EP-A-355 443 (U.S. Pat. No. 5,087,739), (cyclo)aliphatic diisocyanates, e.g. hexamethylene 1,6-diisocyanate (HDI), isomeric aliphatic diisocyanates having 6 carbon atoms in the alkylene radical, 4,4′- or 2,4′-di(isocyanatocyclohexyl)methane and 1-isocyanato-3-isocyanatomethyl-3,5,5-trimethylcyclohexane (isophorone diisocyanate or IPDI) can be prepared by reacting the (cyclo)aliphatic diamines with, for example, urea and alcohols to form (cyclo)aliphatic biscarbamic esters and thermal dissociation of these into the corresponding diisocyanates and alcohols. The synthesis is usually carried out continuously in a circulatory process and optionally in the presence of N-unsubstituted carbamic esters, dialkyl carbonates and other by-products recirculated from the reaction process. Diisocyanates obtained in this way generally have a very small or even unmeasurable proportion of chlorinated reaction products, which is advantageous, for example, in applications in the electronics industry, without being restricted thereto.

It can be advantageous for the isocyanates used to have a total content of hydrolyzable chlorine of less than 200 ppm, preferably less than 120 ppm, particularly preferably less than 80 ppm, very particularly preferably less than 50 ppm, in particular less than 15 ppm and especially less than 10 ppm. This can, for example, be measured according to the ASTM method D4663-98. However, it is of course also possible to use monomeric isocyanates having a higher chlorine content, for example up to 500 ppm.

It is of course also possible to use mixtures of monomeric isocyanates which have been obtained by reaction of the (cyclo)aliphatic diamines with, for example, urea and alcohols and dissociation of the resulting (cyclo)aliphatic biscarbamic esters with diisocyanates which have been obtained by phosgenation of the corresponding amines.

The at least one polyisocyanate to which the monomeric isocyanates can be polymerized generally has the following characteristics:

The average NCO functionality of the at least one polyisocyanate is generally at least 1.8 and can be up to 8, for example up to 6, preferably from 2 to 5 and particularly preferably from 2.4 to 4.

The content of isocyanate groups after the polymerization, calculated as NCO=42 g/mol, is, unless indicated otherwise, generally from 5 to 30% by weight.

The at least one polyisocyanate is preferably selected from among the following compounds:
1) one or more polyisocyanates having isocyanurate groups and derived from aromatic, aliphatic and/or cycloaliphatic diisocyanates. Particular preference is given here to the corresponding aliphatic and/or cycloaliphatic isocyanatoisocyanurates and in particular those based on hexamethylene diisocyanate and isophorone diisocyanate. The isocyanurates present here are, in particular, trisisocyanatoalkyl or trisisocyanatocycloalkyl isocyanurates, which represent cyclic trimers of the diisocyanates, or mixtures with their higher homologs having more than one isocyanurate ring. The isocyanatoisocyanurates generally have an NCO content of from 10 to 30% by weight, in particular from 15 to 25% by weight, and an average NCO functionality of from 2.6 to 8. The polyisocyanates having isocyanurate groups can also contain smaller amounts of urethane and/or allophanate groups, preferably with a content of bound alcohol of less than 2% by weight based on the polyisocyanate.
2) One or more polyisocyanates having uretdione groups and aromatically, aliphatically and/or cycloaliphatically bound isocyanate groups, preferably aliphatically and/or cycloaliphatically bound isocyanate groups, and in particular those derived from hexamethylene diisocyanate or isophorone diisocyanate. Uretdione diisocyanates are cyclic dimerization products of diisocyanates.
   Polyisocyanates having uretdione groups are frequently obtained in admixture with other polyisocyanates, in particular those mentioned under item 1). Polyisocyanates having uretdione groups usually have NCO functionalities of from 2 to 3.
   For this purpose, the diisocyanates can be reacted under reaction conditions under which both uretdione groups and also the other polyisocyanates are formed, or the uretdione groups are formed first and these are subsequently converted into the other polyisocyanates or the diisocyanates are firstly reacted to form the other polyisocyanates and these are subsequently converted into products comprising uretdione groups.
3) One or more polyisocyanates having biuret groups and aromatically, cycloaliphatically or aliphatically bound, preferably cycloaliphatically or aliphatically bound, isocyanate groups, in particular tris(6-isocyanatohexyl)biuret or mixtures thereof with its higher homologs. These polyisocyanates having biuret groups generally have an NCO content of from 18 to 24% by weight and an average NCO functionality of from 2.8 to 6.
4) One or more polyisocyanates having urethane and/or allophanate groups and aromatically, aliphatically or cycloaliphatically bound, preferably aliphatically or cycloaliphatically bound, isocyanate groups, as are obtained, for example, by reaction of excesses of diisocyanate, for example hexamethylene diisocyanate or isophorone diisocyanate, with monohydric or polyhydric alcohols. These polyisocyanates having urethane and/or allophanate groups generally have an NCO content of from 12 to 24% by weight and an average NCO functionality of from 2.0 to 4.5.
   Such polyisocyanates having urethane and/or allophanate groups can be prepared in the absence of catalysts or preferably in the presence of catalysts, for example ammonium carboxylates or ammonium hydroxides or allophanatization catalysts, e.g. bismuth compounds, cobalt compounds, cesium compounds, Zn(II) or Zr(IV) compounds, in each case in the presence of monohydric, dihydric or polyhydric, preferably monohydric, alcohols.
   Polyisocyanates having urethane and/or allophanate groups frequently occur in mixed forms with the polyisocyanates mentioned under item 1).
5) One or more polyisocyanates comprising oxadiazinetrione groups, preferably derived from hexamethylene diisocyanate or isophorone diisocyanate. Such polyisocyanates comprising oxadiazinetrione groups can be obtainable from diisocyanate and carbon dioxide.
6) One or more polyisocyanates comprising iminooxadiazinedione groups, preferably derived from hexamethylene diisocyanate or isophorone diisocyanate. Such polyisocyanates comprising iminooxadiazinedione groups can be prepared, for example, from diisocyanates by means of specific catalysts.
7) One or more uretonimine-modified polyisocyanates.
8) One or more carbodiimide-modified polyisocyanates.
9) One or more hyperbranched polyisocyanates as are known, for example, from DE-A 10013186 or DE-A 10013187.
10) The polyisocyanates 1)-9) described under the abovementioned items, preferably 1), 2), 3), 4) and 6), can, after they have been prepared, be converted into polyisocyanates having biuret groups or urethane/allophanate groups and aromatically, cycloaliphatically or aliphatically bound, preferably (cyclo)aliphatically bound, isocyanate groups. The formation of biuret groups is effected, for example, by addition of water or reaction with amines. The formation of urethane and/or allophanate groups is effected by reaction with monohydric, dihydric or polyhydric, preferably monohydric, alcohols, optionally in the presence of suitable catalysts. These polyisocyanates having biuret or urethane/allophanate groups generally have an NCO content of from 10 to 25% by weight and an average NCO functionality of from 3 to 8.
11) Polyisocyanates which comprise not only the groups described under 1) to 10) but also groups which are formally formed by addition of molecules having NCO-reactive groups and groups which are crosslinkable by means of UV or actinic radiation onto the isocyanate groups of the above molecules. These molecules are, for example, hydroxyalkyl (meth)acrylates and other hydroxyvinyl compounds.

The diisocyanates or polyisocyanates described above can also be present at least partly in blocked form.

Classes of compounds used for blocking are described in D. A. Wicks, Z. W. Wicks, Progress in Organic Coatings, 36, 148-172 (1999), 41, 1-83 (2001) and 43, 131-140 (2001).

Examples of classes of compounds used for blocking are phenols, imidazoles, triazoles, pyrazoles, oximes, N-hydroxyimides, hydroxybenzoic esters, secondary amines, lactams, CH-acidic cyclic ketones, malonic esters or alkyl acetoacetates.

It can be advantageous for the at least one polyisocyanate to be selected from the group consisting of isocyanurates, biurets, urethanes and allophanates, preferably from the group consisting of isocyanurates, urethanes and allophanates, with particular preference being given to a polyisocyanate comprising isocyanurate groups.

The at least one polyisocyanate is particularly preferably a polyisocyanate based on aliphatic diisocyanates, very particularly preferably based on hexamethylene 1,6-diisocyanate.

Further particular preference is given to the at least one polyisocyanate being a mixture of polyisocyanates, very particularly preferably polyisocyanates based on hexamethylene 1,6-diisocyanate and polyisocyanates based on isophorone diisocyanate.

In a particularly preferred embodiment, the at least one polyisocyanate is a mixture comprising low-viscosity polyisocyanates, preferably low-viscosity polyisocyanates comprising isocyanurate groups, having a viscosity of from 600 to 3500 mPa*s, in particular less than 1500 mPa*s, low-viscosity urethanes and/or allophanates having a viscosity of from 200 to 1600 mPa*s, in particular from 500 to 1500 mPa*s, and/or polyisocyanates comprising iminooxadiazinedione groups and having a viscosity of from 400 to 2000 mPa*s, in particular from 500 to 1500 mPa*s.

The viscosity values reported in this document are determined in accordance with DIN EN ISO 3219/A.3 (October 1994) at 23° C. using a cone-plate system at a shear rate of 1000 s⁻¹, unless indicated otherwise.

The at least one polyisocyanate can, for example, be prepared by methods known to those skilled in the art.

The process for preparing the at least one polyisocyanate can be carried out as described in WO 2008/68198, there in particular on page 20, line 21 to page 27, line 15, which is hereby incorporated by reference into the present patent application.

The reaction can, for example, be stopped as described there on page 31, line 19 to page 31, line 31 and the work-up can be carried out as described there on page 31, line 33 to page 32, line 40, which is in each case incorporated by reference into the present patent application.

The reaction can, as an alternative, also be stopped as described in WO 2005/087828 on page 11, line 12 to page 12, line 5, which is hereby incorporated by reference into the present patent application.

In the process for preparing the at least one polyisocyanate, it is possible to use both catalysts which are not thermally labile and catalysts which are thermally labile.

If thermally labile catalysts are used in the process for preparing the at least one polyisocyanate, it is also possible to stop the reaction by heating the reaction mixture to a temperature above at least 80° C., preferably at least 100° C., particularly preferably at least 120° C. The heating of the reaction mixture as is necessary to separate off the unreacted isocyanate by distillation in the work-up is generally sufficient for this purpose.

Both in the case of catalysts which are not thermally labile and in the case of thermally labile catalysts, it is possible to stop the reaction at lower temperatures by addition of deactivators. Suitable deactivators are, for example, hydrogen chloride, phosphoric acid, organic phosphates such as dibutyl phosphate or diethyl hexyl phosphate, carbamates such as hydroxyalkyl carbamate or organic carboxylic acids.

These compounds are added neat or diluted in a suitable concentration required for terminating the reaction.

Diisocyanates, triisocyanates and higher polyisocyanates can, for example, be obtained by phosgenation of corresponding aniline/formaldehyde condensates and can be polyphenyl polyisocyanates having methylene bridges.

The water-emulsifiable polyisocyanate component comprises, as component b), at least one reaction product of at least one polyisocyanate b1) with at least one compound b2).

At least one reaction product means one reaction product or a mixture of two or more reaction products which differ in terms of the components b1) and/or b2), with preference being given to one reaction product.

The at least one polyisocyanate can be identical to or different from the at least one polyisocyanate described under a). The at least one polyisocyanate used under b1) is preferably identical to the at least one polyisocyanate under a).

At least one compound b2) means a mixture of two or more different compounds b2), with preference being given to one compound b2).

The at least one compound b2) can be a monomer, oligomer or polymer.

The at least one compound b2) comprises one group which is reactive toward isocyanate (isocyanate-reactive group B).

For the purposes of the present invention, a group which is reactive toward isocyanate (group B) is a group which has hydrogen atoms which are reactive toward NCO groups or which can form an adduct with NCO groups under the normal process conditions in the reaction. These process conditions are known per se to those skilled in the art.

This group B is, for example, a hydroxy, mercapto, primary or secondary amino group (NH group for short), an epoxide, an acid anhydride group or a carbodiimide group. Preference is given to a hydroxy, mercapto or primary or secondary amino group (NH group for short). Particular preference is given to a hydroxy group.

The at least one compound b2) comprises at least one hydrophilic group which is not reactive toward isocyanate (group A).

For the purposes of the present invention, a group which is not reactive toward isocyanate (non-isocyanate-reactive group A) is a group which cannot form an adduct with NCO groups under the normal process conditions in the reaction. These process conditions are known per se to those skilled in the art.

The group A can be, for example, an ionic group or a group which can be converted into an ionic group.

Anionic groups or groups which can be converted into anionic groups are, for example, carboxylic or sulfonic acid groups.

Cationic groups or groups which can be converted into cationic groups are, for example, quaternary ammonium groups or (tertiary) amino groups.

Groups which can be converted into ionic groups are preferably converted into ionic groups before or during dispersion of the mixture according to the invention in water. With particular preference the groups which can be converted into ionic groups are already converted into ionic groups prior to the reaction with the polyisocyanate.

The conversion of, for example, carboxylic acid groups or sulfonic acid groups into anionic groups can be carried out using inorganic and/or organic bases such as sodium hydroxide, potassium hydroxide, potassium carbonate, sodium hydrogencarbonate, ammonia or primary, secondary and in particular tertiary amines, e.g. triethylamine or dimethylaminopropanol.

To convert tertiary amino groups into the corresponding cations, e.g. ammonium groups, suitable neutralizing agents are inorganic or organic acids, e.g. hydrochloric acid, acetic acid, fumaric acid, maleic acid, lactic acid, tartaric acid, oxalic acid or phosphoric acid, and suitable quaternizing agents are, for example, methyl chloride, methyl iodide, dimethyl sulfate, benzyl chloride, ethyl chloroacetate or bromoacetamide. Further suitable neutralizing agents and quaternizing agents are, for example, described in U.S. Pat. No. 3,479,310, column 6.

The content of ionic groups or groups which can be converted into ionic groups is preferably from 0.5 to 30 mol per kg, more preferably from 2 to 15 mol per kg of the sum of the components a) and b).

The group A can, for example, be a nonionic, hydrophilic group.

Nonionic groups are, for example, polyalkylene ether groups, in particular those having from 3 to 80, more preferably 5 to 25, very preferably 5 to 15 alkylene oxide units.

Preference is given to polyethylene ether groups or polyalkylene ether groups which comprise at least 5 ethylene oxide units in addition to other alkylene oxide units, e.g. propylene oxide.

The content of the hydrophilic nonionic groups, in particular the polyalkylene ether groups, is preferably from 0.5 to 20% by weight, particularly preferably from 1 to 30% by weight, based on the sum of the components a) and b).

Compounds suitable as at least one compound b2) are, for example, aliphatic, cycloaliphatic, araliphatic or aromatic hydroxycarboxylic acids, such as hydroxypivalic acid, or hydroxysulfonic or aminosulfonic acids.

The at least one compound b2) is preferably mercaptoacetic acid, mercaptopropionic acid, thiolactic acid, mercaptosuccinic acid, glycine, iminodiacetic acid, sarcosine, alanine, b-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbuttyric acid, ethylenediaminetriacetic acid, hydroxydodecanoic acid, hydroxyhexadecanoic acid, 12-hydroxystearic acid, aminonaphthalenecarboxylic acid, hydroxethanesulfonic acid, hydroxypropanesulfonic acid, mercaptoethanesulfonic acid, mercaptopropanesulfonic acid, aminomethanesulfonic acid, taurine, aminopropanesulfonic acid, N-cyclohexylamino-propanesulfonic acid, N-cyclohexylaminoethanesulfonic acid and also alkali metal, alkaline earth metal or ammonium salts thereof and particularly preferably the abovementioned monohydroxy-carboxylic and -sulfonic acids and monoamino-carboxylic and -sulfonic acids.

The at least one compound b2) is likewise preferably polyalkylene ether alcohols, particularly preferably polyethylene ether alcohols.

The polyalkylene ether alcohols and polyethylene ether alcohols preferably have a molecular weight Mₙ of at least 250, particularly preferably at least 300 g/mol. The molecular weight Mₙ can in principle have no upper limit, and be preferably up to 5000 g/mol, particularly preferably up to 1200 g/mol, and very particularly preferably up to 800 g/mol.

Preferred OH numbers of the polyalkylene ether alcohols and polyethylene ether alcohols, measured in accordance with DIN 53240-2 (November 2007) (potentiometric), are 40-200 mg KOH/g solid resin, preferably 50-160 mg KOH/g of solid resin.

To prepare component b), the at least one polyisocyanate b1) is reacted with at least one compound b2).

The preparation of the component b) is known, for example, from DE-A-35 21 618, DE-A-40 01 783 and DE-A-42 03 51 O.

In the preparation, the at least one compound b2) can be reacted with part of the component a) and subsequently mixed with the remainder of the component a).

However, the preparation can also be carried out by the at least one compound b2) being added to the total amount of the component a) and the reaction then being carried out in the same reaction vessel.

Preferred components b) are compounds having hydrophilic, nonionic groups, in particular polyalkylene ether groups. The water-emulsifiability is here preferably achieved solely by means of the hydrophilic nonionic groups.

The polyacrylate component comprises an aqueous polymer dispersion c) of at least one hydroxy-functional poly(meth)acrylate having bimodal or polymodal particle size distribution.

The aqueous polymer dispersion c) preferably consists essentially of two or more hydroxyl-functional poly(meth)acrylates having different Dw values, and water.

It will be appreciated that the Dw values for the at least one hydroxy-functional poly(meth)acrylate need not be the same exactly, when they are said to be identical, but instead may vary somewhat, for example by ±45 nm, preferably by ±40 nm, more preferably by ±30 nm, and more particularly by ±20 nm.

It will be appreciated that the terms large and small used hereinafter in relation to the particle size should be interpretated only in a relative sense (both are small in the sense that they afford polymer dispersions).

With regard to the at least one hydroxy-functional poly(meth)acrylate it is preferred for the contribution of particles (independently of the number of maxima) having a size of between 20 and 300 nm to be in the range from 2 to 85 wt % and more preferably from 15 to 60 wt %, based on the total weight of poly(meth)acrylates. Moreover, the contribution of particles having a size of between 150 and 700 nm is preferably in the range from 15 to 98 wt % and more preferably from 40 to 85 wt %, based on the total weight of poly(meth)acrylate, even if the small particles are numerically dominant. Consequently, the weight ratio between the large particles and the small particles is preferably in the range from 15:85 to 98:2, preferably 30:70 to 98:2, and more preferably 40:60 to 85:15.

It may be advantageous if the at least one hydroxy-functional poly(meth)acrylate has a particle size distribution in which two maxima prevail (i.e., bimodal). The weight-average particle diameter Dw of the small particles is preferably 20 to 300 nm and more preferably 30 to 180 nm. The weight-average particle diameter Dw of the large particles is preferably 150 to 700 nm and more preferably 180 to 500 nm. The difference between the weight-average diameter Dw of the small and of the large particles is preferably at least 50 nm, preferably at least 80 nm, and more preferably 100 nm.

Preferred OH numbers of the at least one hydroxy-functional poly(meth)acrylate, measured according to DIN 53240-2 (November 2007) (by potentiometry), are 15-250 mg KOH/g polymethacrylate, preferably 40-120 mg KOH/g.

The at least one hydroxy-functional poly(meth)acrylate preferably is hydroxy-group-containing copolymers of at least one hydroxy-group-containing (meth)acrylate with at least one further polymerizable comonomer selected from the group consisting of alkyl (meth)acrylates, vinylaromatics, α,β-unsaturated carboxylic acids, and other monomers.

The at least one hydroxy-functional poly(meth)acrylate may be prepared by polymerization according to customary methods, as for example via emulsion polymerization.

Preference is given to the copolymerization of hydroxy-functional monomers in a mixture with other polymerizable monomers, preferably radically polymerizable monomers.

In the copolymerization, the hydroxy-functional monomers may be included for use preferably in amounts such as to result in the aforementioned hydroxyl numbers for the at least one hydroxy-functional poly(meth)acrylate, said hydroxyl numbers corresponding generally to a hydroxyl group content in the at least one hydroxy-functional poly(meth)acrylate of 0.5 to 8, preferably 1.2 to 3.8 wt %.

Examples of alkyl (meth)acrylates include C₁-C₂₀ alkyl (meth)acrylates, vinylaromatics are those having up to 20 carbon atoms, α,β-unsaturated carboxylic acids also include their anhydrides, and other monomers are, for example, vinyl esters of carboxylic acids containing up to 20 carbon atoms, ethylenically unsaturated nitriles, vinyl ethers of alcohols containing 1 to 10 carbon atoms, and, less preferably, aliphatic hydrocarbons having 2 to 8 carbon atoms and 1 or 2 double bonds.

Examples of alkyl (meth)acrylates include methyl (meth)acrylate, ethyl (meth)acrylate, n-propyl (meth)acrylate, n-butyl (meth)acrylate, isobutyl (meth)acrylate, sec-butyl (meth)acrylate, n-pentyl (meth)acrylate, isopentyl (meth)acrylate, 2-methylbutyl (meth)acrylate, amyl (meth)acrylate, n-hexyl (meth)acrylate, 2-ethylbutyl (meth)acrylate, pentyl (meth)acrylate, n-heptyl (meth)acrylate, n-octyl (meth)acrylate, 2-ethylhexyl (meth)acrylate, 2-propylheptyl (meth)acrylate, n-decyl (meth)acrylate, undecyl (meth)acrylate and/or n-dodecyl (meth)acrylate.

Preferred alkyl (meth)acrylates are those having a C₁-C₁₀ alkyl radical, particular preference being given to methyl methacrylate, methyl acrylate, ethyl acrylate, n-butyl acrylate, n-butyl methacrylate, n-hexyl acrylate, n-octyl acrylate, 2-ethylhexyl acrylate and/or 3-propylheptyl acrylate.

In particular, mixtures of the alkyl (meth)acrylates are also suitable.

Vinyl esters of carboxylic acids having from 1 to 20 carbon atoms are, for example, vinyl laurate, vinyl stearate, vinyl propionate and vinyl acetate.

α,β-Unsaturated carboxylic acids and anhydrides thereof can be, for example, acrylic acid, methacrylic acid, fumaric acid, crotonic acid, itaconic acid, maleic acid or maleic anhydride, preferably acrylic acid.

As hydroxy-functional monomers, mention may be made of monoesters of α,β-unsaturated carboxylic acids, for example acrylic acid, methacrylic acid (in this text referred to as “(meth)acrylic acid” for short), with diols or polyols which preferably have from 2 to 20 carbon atoms and at least two hydroxy groups, e.g. ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, the hydroxypivalic ester of neopentyl glycol, 2-ethyl-1,3-propanediol, 2-methyl-1,3-propanediol, 2-butyl-2-ethyl-1,3-propanediol, 1,6-hexanediol, 2-methyl-1,5-pentanediol, 2-ethyl-1,4-butanediol, 2-ethyl-1,3-hexanediol, 2,4-diethyloctane-1,3-diol, 2,2-bis(4-hydroxycyclohexyl)propane, 1,1-, 1,2-, 1,3- and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomaltol, polyTHF having a molecular weight in the range from 162 to 4500, preferably from 250 to 2000, poly-1,3-propanediol or polypropylene glycol having a molecular weight in the range from 134 to 2000 or polyethylene glycol having a molecular weight in the range from 238 to 2000.

Preference is given to 2-hydroxyethyl acrylate, 2-hydroxyethyl methacrylate, 2- or 3-hydroxypropyl acrylate, 1,4-butanediol monoacrylate or 3-(acryloyloxy)-2-hydroxypropyl acrylate and particular preference is given to 2-hydroxyethyl acrylate and/or 2-hydroxyethyl methacrylate.

Possible vinylaromatic compounds are, for example, vinyltoluene, α-butylstyrene, α-methylstyrene, 4-n-butylstyrene, 4-n-decylstyrene and preferably styrene.

Examples of nitriles are acrylonitrile and methacrylonitrile.

Suitable vinyl ethers are, for example, vinyl methyl ether, vinyl isobutyl ether, vinyl hexyl ether and vinyl octyl ether.

As nonaromatic hydrocarbons having from 2 to 8 carbon atoms and one or two olefinic double bonds, mention may be made of butadiene, isoprene and also ethylene, propylene and isobutylene.

It is also possible to use N-vinylformamide, N-vinylpyrrolidone and N-vinylcaprolactam, also ethylenically unsaturated acids, in particular carboxylic acids, acid anhydrides or acid amides, and also vinylimidazole. Comonomers having epoxide groups, e.g. glycidyl acrylate or methacrylate, or monomers such as N-methoxymethylacrylamide or N-methoxymethacrylamide can also be concomitantly used in small amounts.

Preference is given to esters of acrylic acid or of methacrylic acid having from 1 to 18, preferably from 1 to 8, carbon atoms in the alcohol radical, e.g. methyl acrylate, ethyl acrylate, isopropyl acrylate, n-propyl acrylate, n-butyl acrylate, 2-ethylhexyl acrylate, n-stearyl acrylate, the methacrylates corresponding to these acrylates, styrene, alkyl-substituted styrenes, acrylonitrile, methacrylonitrile, vinyl acetate or vinyl stearate or any mixtures of such monomers.

In the copolymerization of the (meth)acrylates which carry hydroxyl groups, the hydroxy-functional monomers are used in a mixture with other polymerizable monomers, preferably radically polymerizable monomers, preferably those which consist to an extent of more than 50 wt % of C₁-C₂₀, preferably C₁ to C₄ alkyl (meth)acrylate, (meth)acrylic acid, vinylaromatics having up to 20 carbon atoms, vinyl esters of carboxylic acids containing up to 20 carbon atoms, vinyl halides, nonaromatic hydrocarbons having 4 to 8 carbon atoms and 1 or 2 double bonds, unsaturated nitriles, and mixtures thereof. Particularly preferred polymers are those which in addition to the monomers which carry hydroxyl groups consist to an extent of more than 60 wt % of C₁-C₁₀ alkyl (meth)acrylates, styrene and derivatives thereof, or mixtures of these.

The copolymerization of the at least one hydroxy-functional poly(meth)acrylate takes place in general by radically initiated aqueous emulsion polymerization.

The implementation of radically initiated aqueous emulsion polymerizations has been the subject of many prior descriptions and is therefore sufficiently well-known to the skilled person [in this regard, see Emulsion Polymerization in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerization, Interscience Publishers, New York (1965); DE-A 40 03 422 and Dispersionen synthetischer Hochpolymerer, F. Hölscher, Springer-Verlag, Berlin (1969)]. The usual format for the radically initiated aqueous emulsion polymerization is that the monomers are dispersed in the aqueous medium, generally with accompaniment of dispersing assistants, such as emulsifiers and/or protective colloids, and are polymerized by means of at least one water-soluble radical polymerization initiator. In the aqueous polymer dispersions obtained, the residual levels of unreacted monomers are frequently lowered by means of chemical and/or physical methods that are likewise known to the skilled person [see, for example, EP-A 771328, DE-A 19624299, DE-A 19621027, DE-A 19741184, DE-A 19741187, DE-A 19805122, DE-A 19828183, DE-A 19839199, and DE-A 19840586 and 19847115], the polymer solids content is adjusted to a desired figure by dilution or concentration, or further customary adjuvants, such as foam- or viscosity-modifying additives, for example, are added to the aqueous polymer dispersion.

The radically initiated aqueous emulsion polymerization may take place in a multistage polymerization process. A multistage polymerization process refers to the sequential polymerization of two or more separate monomer mixtures in two or more separate operations. The radically initiated aqueous emulsion polymerization is carried out generally in the presence of 0.1 to 5 wt %, preferably 0.1 to 4 wt %, and more particularly 0.1 to 3 wt %, based in each case on the total monomer amount, of a radical polymerization initiator (radical initiator). Radical initiators contemplated include all those capable of initiating a radical aqueous emulsion polymerization. These may in principle be both peroxides and azo compounds. It will be appreciated that redox initiator systems are also contemplated. As peroxides it is possible in principle to use inorganic peroxides, such as hydrogen peroxide or peroxodisulfates, such as the mono- or di-alkali metal or ammonium salts of peroxodisulfuric acid, such as its mono- and di-sodium, -potassium, or ammonium salts, for example, or organic peroxides, such as alkyl hydroperoxides, examples being tert-butyl, p-menthyl, or cumyl hydroperoxide, and also dialkyl or diaryl peroxides, such as di-tert-butyl peroxide or dicumyl peroxide. As azo compound, use is made substantially of 2,2″-azobis(isobutyronitrile), 2,2″-azobis(2,4-dimethylvaleronitrile), and 2,2″-azobis(amidinopropyl) dihydrochloride (AIBA, corresponding to V-50 from Wako Chemicals). It will be appreciated that systems known as redox initiator systems can also be used as radical initiators. Oxidizing agents contemplated for redox initiator systems are essentially the peroxides identified above. As corresponding reducing agents it is possible to use sulfur compounds with a low oxidation state, such as alkali metal sulfites, as for example potassium and/or sodium sulfite, alkali metal hydrogensulfites, as for example potassium and/or sodium hydrogensulfite, alkali metabisulfites, as for example potassium and/or sodium metabisulfite, formaldehyde-sulfoxylates, as for example potassium and/or sodium formaldehyde-sulfoxylate, alkali metal salts, especially potassium salts and/or sodium salts aliphatic sulfinic acids, and alkali metal hydrogensulfides, such as potassium and/or sodium hydrogensulfide, for example, salts of polyvalent metals, such as iron(II) sulfate, iron(II) ammonium sulfate, iron(II) phosphate, enediols, such as dihydroxymaleic acid, benzoin and/or ascorbic acid, and also reducing saccharides, such as sorbose, glucose, fructose and/or dihydroxyacetone.

Initiation of the polymerization reaction means the start of the polymerization reaction of the monomers present in the polymerization vessel, after radical formation by the radical initiator. This initiation of the polymerization reaction may be accomplished by adding radical initiator to the aqueous polymerization mixture in the polymerization vessel under polymerization conditions. Another possibility, however, is to add a portion or the entirety of the radical initiator to the aqueous polymerization mixture, comprising the initially introduced monomers, in the polymerization vessel, under conditions not apt to trigger a polymerization reaction—at low temperature, for example—and thereafter to bring about polymerization conditions in the aqueous polymerization mixture. Polymerization conditions here are, generally, those temperatures and pressures at which the radically initiated aqueous emulsion polymerization proceeds with sufficient polymerization rate. They are dependent in particular on the radical initiator used. Advantageously, the nature and amount of the radical initiator, the polymerization temperature, and the polymerization pressure are selected such that the radical initiator has a half-life <3 hours and especially advantageously <1 hour and at the same time there are always sufficient initiating radicals available to initiate and maintain the polymerization reaction.

Reaction temperatures contemplated for the radically initiated aqueous emulsion polymerization span the whole range from 0 to 170° C. Temperatures employed here are generally from 50 to 120° C., preferably 60 to 110° C., and especially preferably 60 to 100° C. The radically initiated aqueous emulsion polymerization may be carried out at a pressure less than, equal to, or greater than 1 atm [1.013 bar (absolute), atmospheric pressure], and so the polymerization temperature may exceed 100° C. and may be up to 170° C. In the presence of monomers having a low boiling point, the emulsion polymerization is carried out preferably under increased pressure. In that case the pressure may take on values of 1.2, 1.5, 2, 5, 10, or 15 bar (absolute) or even higher. If the emulsion polymerization is carried out under subatmospheric pressure, pressures of 950 mbar, frequently of 900 mbar and often 850 mbar (absolute), are set. The radical aqueous emulsion polymerization is carried out advantageously at 1 atm in the absence of oxygen, more particularly under inert gas atmosphere, such as under nitrogen or argon, for example.

In accordance with the invention, the entirety of the radical initiator may be included in the initial charge in the aqueous reaction medium before the polymerization reaction is initiated. Another possibility, however, is to include optionally only a portion of the radical initiator in the initial charge in the aqueous reaction medium before the polymerization reaction is initiated, and then to add the entirety or any remainder during the radically initiated emulsion polymerization, under polymerization conditions, at the rate of its consumption, continuously or discontinuously. In a preferred embodiment, the entirety of the radical initiator is included in the initial charge in the aqueous reaction medium before the polymerization reaction is initiated.

Generally speaking, the total amount of radical initiators is ≥0.05 and ≤5 wt %, preferably ≥0.1 and ≤3 wt %, and more preferably ≥0.1 and ≤1.5 wt %, based in each case on the total monomer amount.

In order to set the weight-average molecular weights, optionally, compounds that bring about radical chain transfer (chain transfer agents) are used. Employed in this context essentially are aliphatic and/or araliphatic halogen compounds, such as, for example, n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary, or tertiary aliphatic thiols, such as, for example, ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as, for example, 2-hydroxyethanethiol, aromatic thiols, such as benzenethiol, ortho-, meta-, or para-methylbenzenethiol, mercaptoalkanoic acid and derivatives thereof, such as 6-methylheptyl 3-mercaptopropionate or 2-ethylhexyl 2-mercaptoethanoate, and all further sulfur compounds described in the third edition of the Polymer Handbook, 1989, J. Brandrup and E. H. Immergut, John Wiley & Sons, section II, pages 133 to 141 and also aliphatic and/or aromatic aldehydes, such as acetaldehyde, propionaldehyde and/or benzaldehyde, unsaturated fatty acids, such as oleic acid, dienes having nonconjugated double bonds, such as divinylmethane or vinylcyclohexane, or hydrocarbons having readily abstractable hydrogen atoms, such as toluene, for example. An alternative possibility is to use mixtures of mutually nondisruptive aforementioned chain transfer agents.

The entirety of the chain transfer agent may be included in the initial charge in the aqueous reaction medium before the polymerization reaction is initiated. Another possibility, however, is to include optionally only a portion of the chain transfer agent in the initial charge in the aqueous reaction medium before the polymerization reaction is initiated, and then to add the entirety or any remainder during the radically initiated emulsion polymerization, under polymerization conditions, as and when required, continuously or discontinuously. It is essential, however, that the nature and the amounts of the chain transfer agents are selected such that the stated weight-average molecular weights are obtained.

Generally speaking, the amount of chain transfer agent is 0 to 20 wt %, preferably 0.05 to 10 wt %, and more preferably 0.1 to 1 wt %, based in each case on the total monomer amount. The emulsion polymerization may optionally also be carried out in the presence of dispersing assistants, which keep both the monomer droplets and polymer particles in dispersion in the aqueous phase and so ensure the stability of the aqueous dispersions produced of the dispersion polymers. Compounds contemplated as such dispersing assistants include emulsifiers as well as the protective colloids that are customarily used in the implementation of radical aqueous emulsion polymerizations.

Examples of suitable protective colloids are polyvinyl alcohols, cellulose derivatives, or copolymers comprising vinylpyrrolidone. A comprehensive description of further suitable protective colloids is found in Houben-Weyl, Methoden der organischen Chemie, volume XIV/1, Makromolekulare Stoffe [Macromolecular compounds], pages 411 to 420, Georg-Thieme-Verlag, Stuttgart, 1961. It will be appreciated that mixtures of emulsifiers and/or protective colloids can also be used. As dispersing assistants it is preferred to use exclusively emulsifiers, whose relative molecular weights, in contrast to the protective colloids, are customarily below 1000 g/mol. They may be anionic, cationic, or nonionic in nature. Where mixtures of surface-active substances are used, the individual components must of course be compatible with one another, something which in the event of doubt can be verified by means of a few preliminary tests. Generally speaking, anionic emulsifiers are compatible with one another and with nonionic emulsifiers. The same also applies to cationic emulsifiers, whereas anionic and cationic emulsifiers are usually not compatible with one another. Customary emulsifiers are, for example, ethoxylated mono-, di-, and tri-alkylphenols (EO degree: 3 to 50, alkyl radical: C4 to C12), ethoxylated fatty alcohols (EO degree: 3 to 50; alkyl radical: C8 to C36), and alkali metal salts and ammonium salts of alkyl sulfates (alkyl radical: C8 to C12), of sulfuric monoesters with ethoxylated alkanols (EO degree: 4 to 30, alkyl radical: C12 to C18) and with ethoxylated alkylphenols (EO degree: 3 to 50, alkyl radical: C4 to C12), of alkylsulfonic acids (alkyl radical: C12 to C18), and of alkylarylsulfonic acids (alkyl radical: C9 to C18). Further suitable emulsifiers are found in Houben-Weyl, Methoden der organischen Chemie, volume XIV/1, Makromolekulare Stoffe [Macromolecular compounds], pages 192 to 208, Georg-Thieme-Verlag, Stuttgart, 1961.

Having further proven suitable as surface-active substances are compounds of the general formula I

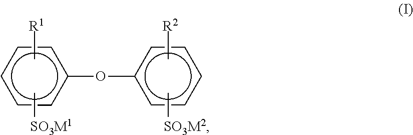

in which R¹ and R² are H atoms or C₄ to C₂₄ alkyl and are not simultaneously H atoms, and M¹ and M² may be alkali metal ions and/or ammonium ions. In the general formula (I), R¹ and R² are preferably linear or branched alkyl radicals having 6 to 18 C atoms, more particularly having 6, 12, and 16 C atoms, or are hydrogen, and R¹ and R² are not both simultaneously H atoms. M¹ and M² are preferably sodium, potassium, or ammonium, with sodium being particularly preferred. Particularly advantageous compounds (I) are those in which M¹ and M² are sodium, R¹ is a branched alkyl radical having 12 C atoms, and R² is an H atom or R¹. Use is frequently made of technical mixtures which have a fraction of 50 to 90 wt % of the monoalkylated product, such as, for example, Dowfax® 2A1 (brand name of the Dow Chemical Company). The compounds (I) are general knowledge, from U.S. Pat. No. 4,269,749, for example, and are available commercially.

Where dispersing assistants are used in accordance with the invention, use is made advantageously of anionic and/or nonionic, and especially advantageously of anionic, surfactants.

It may be advantageous if emulsifiers used are those which are incorporated into the polymer in the course of the radical emulsion polymerization. These are generally compounds which carry at least one radically polymerizable group, preferably selected from the group consisting of allyl, acrylate, methacrylate, and vinyl ether, and at least one emulsifying group, preferably selected from the group indicated above.

These emulsifiers are, for example, incorporable emulsifiers with the brand names Bisomer® MPEG 350 MA from Laporte, Hitenol® BC-20 (APEO), Hitenol® BC-2020, Hitenol® KH-10 or Noigen® RN-50 (APEO) from Dai-lchi Kogyo Seiyaku Co., Ltd., Maxemul® 6106, Maxemul® 6112, Maxemul® 5010, Maxemul® 5011 from Croda, Sipomer® PAM 100, Sipomer® PAM 200, Sipomer® PAM 300, Sipomer® PAM 4000, Sipomer® PAM 5000 from Rhodia, Adeka® Reasoap® PP-70, Adeka® Reasoap® NE-10, Adeka® Reasoap® NE-20, Adeka® Reasoap® NE-30, Adeka® Reasoap® NE-40, Adeka® Reasoap® SE-10N, Adeka® Reasoap® SE-1025A, Adeka® Reasoap® SR-10, Adeka® Reasoap® SR-1025, Adeka® Reasoap® SR-20, Adeka® Reasoap® ER-10, Adeka® Reasoap® ER-20, Adeka® Reasoap® ER-30, Adeka® Reasoap® ER-40 from Adeka, Pluriol® A 010 R, Pluriol® A 12 R, Pluriol® A 23 R, Pluriol® A 46 R, Pluriol® A 750 R, Pluriol® A 950 R, Pluriol® A 590 I, Pluriol® A 1190 I, Pluriol® A 590 V, Pluriol® A 1190 V, Pluriol® A 5890 V, Pluriol® A 308 R and DAA ES 8761 from BASF SE, Latemul® S 180 A and Latemul® S 180 from Kao, Eleminol® JS-2 from Sanyou Kasei, Aquaron® HS-1025 from Daiichi Kogyou Seiyaku and C12-AMPS from Lubrizol.

The entirety of the optionally employed dispersing assistant may be included in the initial charge in the aqueous reaction medium before the polymerization reaction is initiated. Another possibility, however, is to include optionally only a portion of the dispersing assistant in the initial charge in the aqueous reaction medium before the polymerization reaction is initiated, and then to add the entirety or any remainder during the radically initiated emulsion polymerization, under polymerization conditions, as and when required, continuously or discontinuously. Optionally, a portion (≤50 wt %) of the dispersing assistants is included in the initial reaction vessel charge, and the remaining amounts (≥50 wt %) are metered in continuously.

It is significant, however, that the radically initiated aqueous emulsion polymerization may advantageously also be carried out in the presence of a polymer seed, as for example in the presence of 0.01 to 10 wt %, frequently of 0.05 to 7.0 wt %, and often of 0.1 to 4.0 wt % of a polymer seed, based in each case on the total monomer amount.

A polymer seed is employed in particular when the particle size of the polymer particles to be prepared by means of a radically initiated aqueous emulsion polymerization is to be set to a controlled size (in this regard, see, for example, U.S. Pat. No. 2,520,959 and U.S. Pat. No. 3,397,165).

Employed more particularly is a polymer seed whose polymer seed particles have a weight-average diameter Dw ≤100 nm, frequently ≥5 nm to ≤50 nm, and often ≥15 nm to ≤35 nm. The weight-average particle diameters Dw are generally determined according to ISO 13321 using a High Performance Particle Sizer from Malvern, at 22° C. and a wavelength of 633 nm.

The polymer seed is used customarily in the form of an aqueous polymer dispersion.

Where a polymer seed is used, it is advantageous to employ an exogenous polymer seed. Unlike an in situ polymer seed, which is prepared in the reaction vessel before the actual emulsion polymerization is commenced, and which generally has the same monomeric composition as the polymer prepared by the ensuing radically initiated aqueous emulsion polymerization, an exogenous polymer seed is understood to be a polymer seed which has been prepared in a separate reaction step and has a monomeric composition differing from that of the polymer prepared by the radically initiated aqueous emulsion polymerization, although this means nothing more than that different monomers, or monomer mixtures having a differing composition, are used for preparing the exogenous polymer seed and for preparing the aqueous polymer dispersion. Preparing an exogenous polymer seed is familiar to the skilled person and is customarily accomplished by initially charging a reaction vessel with a relatively small amount of monomers and also with a relatively large amount of emulsifiers, and adding a sufficient amount of polymerization initiator at reaction temperature.

With preference in accordance with the invention, an exogenous polymer seed is used that has a glass transition temperature ≥50° C., frequently ≥60° C. or ≥70° C., and often ≥80° C. or ≥90° C. Especially preferred is a polystyrene or polymethyl methacrylate polymer seed.

The total amount of exogenous polymer seed may be included in the initial charge to the polymerization vessel. Another possibility, however, is to include only a portion of the exogenous polymer seed in the initial charge in the polymerization vessel, and to add the remainder during the polymerization together with the monomers. If necessary, however, it is also possible to add the total amount of polymer seed in the course of the polymerization. The total amount of exogenous polymer seed is preferably included in the initial charge to the polymerization vessel before the polymerization reaction is initiated.

In general the aqueous polymer dispersions c) has a solids content in the range of ≥35 and ≤70 wt % and advantageously ≥40 and ≤60 wt %, based in each case on the aqueous polymer dispersion c). The solids content here is determined by drying an aliquot amount (around 1 g) of the aqueous polymer dispersion c) to constant weight at a temperature of 120° C. in an aluminum dish having an internal diameter of around 5 cm.

For preparing the aqueous polymer dispersion c) it is possible in principle to proceed by employing the processes known from the prior art for preparing polymer dispersions having a bimodal or polymodal polymer particle size distribution. Examples include the mixing of at least two different polymer dispersions having a monomodal particle size distribution, with the polymer dispersions differing in their average particle size, as described in EP 81083 and WO 84/04491, for example. Another possibility is to prepare the aqueous polymer dispersion c) by a radically initiated aqueous emulsion polymerization of ethylenically unsaturated monomers in the presence of two different seed lattices which differ in their average particle size. A process of that kind is described likewise in EP 81083. Another procedure that may be adopted for preparing the aqueous polymer dispersion c) is to carry out a radically initiated aqueous emulsion polymerization of the monomers by a monomer feed process, in which, in the course of the polymerization, when some of the monomers have already undergone polymerization, a larger quantity of emulsifier is added, which initiates the formation of a new particle generation. A process of that kind is known from EP 8775, for example.

For the aqueous polymer dispersion c) it is also possible to employ the process described below, that of a radically initiated aqueous emulsion polymerization of the monomers which constitute the polymer. With this process, a radically initiated aqueous emulsion polymerization of the monomers is conducted according to a monomer feed process, where at least one polymer seed 1 is included in the initial charge to the polymerization vessel, and in the course of the polymerization at least one further polymer seed 2 is added in the form of an aqueous dispersion.

A monomer feed process, here and below, means that at least 95% and more particularly at least 99% of the monomers to be polymerized are added under polymerization conditions to a polymerization vessel in which there is already a first polymer seed located, typically in the form of an aqueous dispersion.

The polymer seed 2 is generally added at the earliest when at least 10 wt % and more particularly at least 20 wt % of the monomers to be polymerized are already located in the polymerization vessel. The addition of the polymer seed 2 is generally ended no later than when 90%, more particularly 80%, very preferably 70% or especially 60% of the monomers to be polymerized are located in the reaction vessel. The polymer seed 2 may be added in one portion, in a plurality of portions, or continuously. Particularly preferred is what is called a “seed shot”, meaning that the polymer seed is introduced into the polymerization vessel under polymerization conditions over a short period of time, generally not exceeding 5 minutes. The seed shot is made typically when 10 to 90 wt %, more particularly 10 to 80 wt %, very preferably 15 to 70 wt %, and especially 20 to 60 wt % of the monomers to be polymerized are located in the polymerization vessel.

To produce a two-component coating composition, the polyisocyanate component and the polyacrylate component are mixed with one another.

Mixing is accomplished customarily by the stirred incorporation of the polyisocyanate component into the polyacrylate component, or of the polyacrylate component into the polyisocyanate component.

The mixing of the polyisocyanate component and the polyacrylate component may in principle take place according to various methods, as for example by stirred incorporation by hand, by shaking, by stirred incorporation by laboratory stirrer at defined rotary speeds, and, in the case of spray applications, by the combining and mixing of the two components within the spraying nozzle. Mixing is preferably accomplished by means of manual stirred incorporation. The various methods differ in relation to the shearing, and certain mixing methods are suitable only for systems (isocyanates and formulated dispersions) with sufficient stabilization and appropriate rheological characteristics.

The molar ratio of the isocyanate groups in the polyisocyanate component to the hydroxyl groups in the polyacrylate component is generally from 0.2:1 to 5:1, preferably 0.8:1 to 1.6:1, and especially 0.9:1 to 1.1:1.

The two-component coating composition is especially suitable for use in coating materials and paints.

Where the aforementioned two-component coating composition is used for producing coating materials and paints, the two-component coating composition may additionally comprise pigments, fillers, dispersants, thickeners, preservatives, film-forming assistants, flow control and wetting assistants, solvents, neutralizing agents, defoamers, light stabilizers and/or corrosion inhibitors.

Pigments which can be used in this context include in principle all organic and/or inorganic white and/or chromatic pigments familiar to a person skilled in the art and having a particle size ≤10 000 nm (Brock, Groteklaes, Mischke, Lehrbuch der Lacktechnologie 2^{nd} edition, Ed. U. Zorll, Vincentz Verlag 1998, p. 113).

The most important white pigment for mention, on account of its high refractive index (rutile: 2.70 and anatase: 2.55) and its high hiding power, is titanium dioxide in its various modifications. However, zinc oxide and zinc sulfide as well are used as white pigments. These white pigments may be used in surface-coated or uncoated form. In addition, however, use is also made of organic white pigments, such as, for example, nonfilming hollow polymer particles of high styrene and carboxyl group content, having a particle size of around 300 to 400 nm (referred to as opaque particles).

In addition to white pigments, a very wide variety of chromatic pigments familiar to a person skilled in the art may be used for providing color, examples being the relative inexpensive inorganic iron, cadmium, chromium, and lead oxides and sulfides, lead molybdate, cobalt blue or carbon black, and also the relatively expensive organic pigments, examples being phthalocyanines, azo pigments, quinacridones, perylenes or carbazoles.

In addition to the pigments, the two-component coating composition may of course further comprise fillers, as they are known, which are familiar to a person skilled in the art. Fillers are understood essentially to be inorganic materials in powder form with a particle size ≤10 000 nm (Brock, Groteklaes, Mischke, Lehrbuch der Lacktechnologie 2^{nd} edition, Ed. U. Zorll, Vincentz Verlag 1998, p. 113) having a refractive index lower by comparison with the pigments (white fillers according to DIN 55943 and DIN 55945 have refractive index values <1.7). The fillers in powder form here are often naturally occurring minerals, such as, for example, calcite, chalk, dolomite, kaolin, talc, mica, diatomaceous earth, baryte, quartz or talc/chlorite intergrowths, and also synthetically prepared inorganic compounds, such as, for example, precipitated calcium carbonate, calcined kaolin or barium sulfate, and also fumed silica. A preferred filler used is calcium carbonate in the form of the crystalline calcite or the amorphous chalk.

Corrosion inhibitors contemplated in accordance with the invention are, in particular, corrosion inhibitors or anticorrosion pigments.

Examples of corrosion inhibitors are listed in “Corrosion Inhibitors, 2^{nd} Edition. An industrial Guide”, Ernest W. Flick, Ed.: William Andrew Inc. ISBN: 978-0-8155-1330-8. Preferred corrosion inhibitors are hexamine, benzotriazole, phenylenediamine, dimethylethanolamine, polyaniline, sodium nitrite, cinnamaldehyde, condensation products of aldehydes and amines (imines), chromates, nitrites, phosphates, hydrazine and ascorbic acid.

Examples of anticorrosion pigments are modified zinc orthophosphates (for example HEUCOPHOS® ZPA, ZPO and ZMP), polyphosphates (for example HEUCOPHOS® ZAPP, SAPP, SRPP and CAPP), WSA—Wide Spectrum Anticorrosives (for example HEUCOPHOS® ZAMPLUS and ZCPPLUS) and modified silicate pigments (for example HEUCOSIL® CTF, Halox® 750), for example from the company Heubach GmbH, and also barium boron phosphate (for example Halox® 400), barium phosphosilicates (for example Halox® BW-111, Halox® BW-191), calcium borosilicates (for example Halox® CW-291, CW-22/221, CW-2230), calcium phosphosilicate (for example Halox® CW-491), strontium phosphosilicate (for example Halox® SW-111) or strontium zinc phosphosilicate (for example Halox® SZP-391) from the company Halox®.

Drying is familiar to a person skilled in the art and is accomplished for example in a tunnel oven or by flashing off. Drying may also take place by means of NIR radiation, with NIR radiation referring here to electromagnetic radiation in the wavelength range from 760 nm to 2.5 μm, preferably from 900 to 1500 nm. Drying may take place at a temperature from ambient temperature up to 100° C. over a period of a few minutes to several days.

The two-component coating compositions, especially for use in paints and coating materials, are suitable for coating substrates such as wood, wood veneer, paper, paperboard, card, textile, film, leather, nonwoven, polymer surfaces, glass, ceramic, mineral building materials such as molded cement bricks and fiber cement plates or metals, which can in each case optionally be precoated or pretreated.

Such coating compositions are suitable as or in interior or exterior coatings, i.e. applications which are exposed to daylight, preferably parts of buildings, coatings on (large) vehicles and aircraft and industrial applications, such as commercial vehicles in the agricultural and building sector, decorative surface coatings, bridges, buildings, electric pylons, tanks, containers, pipelines, power stations, chemical plants, ships, cranes, posts, sheet pile walls, valves, pipes, fittings, flanges, couplings, halls, roofs and structural steel, furniture, windows, doors, parquetry floors, can coating and coil coating, for floor coverings as in the case of parking decks or in hospitals, in automobile paints as OEM and refinishing.

In particular, the coating compositions according to the invention are used as clearcoat materials, pigmented and/or equipped with filling media, in primer systems or in basecoat, intercoat or topcoat materials.

Such coating compositions are preferably used at temperatures in the range from ambient temperature up to 80° C., preferably up to 60° C., particularly preferably up to 40° C. Preference is given to articles which cannot be cured at high temperatures, for example large machines, aircraft, large-capacity vehicles and refinishing applications, and also applications to wood (floors, furniture) or floor coatings.

Coating of the substrates is carried out by conventional methods known to those skilled in the art, with at least one coating composition being applied in the desired thickness to the substrate to be coated and the volatile constituents optionally comprised in the coating composition being removed, optionally by heating. This procedure can, if desired, be repeated one or more times. Application to the substrate can be carried out in a known manner, e.g. by spraying, troweling, knife coating, brushing, application by roller, rolling, casting, laminating, backspraying or coextrusion.

The thickness of such a layer to be cured can be from 0.1 μm to a number of mm, preferably from 1 to 2000 μm, particularly preferably from 5 to 200 μm, very particularly preferably from 5 to 60 μm (based on the material coating composition in the state in which the solvent has been removed from the material coating composition).

### EXAMPLES

Preparation and Characterization of Polymer Dispersions

The hydroxyl numbers of the dispersion polymers were determined generally according to DIN 53240-2 (November 2007) (by potentiometry, with an acetylation time of 20 minutes).

The solids contents were determined generally by drying a defined amount of the aqueous polymer dispersion (approximately 0.8 g) to constant weight at a temperature of 130° C., using an HR73 moisture analyzer from Mettler Toledo. Two measurements are carried out in each case, and it is the average of these two measurements that is reported.

The weight-average particle sizes (Dw) were determined according to ISO 13321 using a High Performance Particle Sizer from Malvern, at 22° C. and at a wavelength of 633 nm.

Polymer Dispersion P1

A 2 l polymerization vessel equipped with metering devices and temperature regulation was charged at 20 to 25° C. (room temperature) under a nitrogen atmosphere with
349.0 g of deionized water, and
16.7 g of a 33 wt % polystyrene seed (particle size 30 nm with 16 parts by weight of Disponil® LDBS 20 emulsifier from BASF)
   and this initial charge was heated to 85° C. with stirring. When this temperature has been reached, 1.6 g of a 7 wt % strength aqueous solution of sodium peroxodisulfate were added and the mixture was stirred for five minutes.

Subsequently, with the temperature maintained, feed 1 and feed 2 were metered in continuously over the course of 150 minutes at a constant flow rate. After that, the polymerization mixture was admixed with 0.66 g of 25 wt % strength aqueous ammonia solution. Thereafter the polymerization mixture was allowed to continue reaction at 85° C. for 45 minutes. After that the aqueous polymer dispersion obtained was cooled to room temperature, adjusted to a pH of 7 with 25 wt % strength ammonia solution, and filtered through a 125 μm filter.
Feed 1 (homogeneous mixture of):
234.5 g of deionized water,
25.8 g of Disponil® FES 77 from BASF (32 wt %),
103.8 g of 2-hydroxyethyl methacrylate,
8.3 g of methacrylic acid,
154.0 g of n-butyl acrylate,
286.0 g of methyl methacrylate, and
1.7 g of 2-ethylhexyl thioglycolate
Feed 2:
37.7 g of a 7 wt % strength solution of sodium peroxodisulfate

The polymer dispersion obtained had a solids content of 44.8 wt %. The weight-average particle diameter Dw of the dispersion particles obtained was 132 nm. The hydroxyl number of the dispersion polymer was found to be 79.8 mg KOH/g.

Polymer Dispersion P2

Polymer dispersion P2 was prepared entirely in analogy to the preparation of P1, with the difference that 8.6 g of Disponil® FES 77 from BASF (32 wt %) were included in the initial charge in place of the polystyrene seeds.

The polymer dispersion obtained had a solids content of 44.9 wt %. The weight-average particle diameter of the dispersion particles obtained was 113 nm. The hydroxyl number of the dispersion polymer was found to be 79.8 mg KOH/g.

Polymer Dispersion P3

Polymer dispersion P3 was prepared entirely in analogy to the preparation of P1, with the difference that 1.5 g of the 33 wt % polystyrene seed were included in the initial charge.

The polymer dispersion obtained had a solids content of 44.9 wt %. The weight-average particle diameter of the dispersion particles obtained was 281 nm. The hydroxyl number of the dispersion polymer was found to be 79.6 mg KOH/g.

Performance Testing

Formulation of the Polyacrylate Component

The polymer dispersion P1 serves as a monomodal comparative example.

A polyacrylate component with bimodal particle size distribution B1 was prepared from polymer dispersion P2 and polymer dispersion P3 by 1:1 blending (based on dispersion weight).

The monomodal polyacrylate component CB1 and also the polyacrylate component with bimodal particle size distribution B1 were formulated as follows:

200 g of the polymer dispersion were initially taken. In Comparative Example 1, these 200 g consisted entirely of the monomodal polymer dispersion P1. In Example 1, these 200 g consisted of 100 g each of polymer dispersion P2 and of polymer dispersion P3 (through prior blending; see above). The dispersion was stirred at approximately 600 rpm with a laboratory stirrer having a dissolver disk (Dispermat®) and the following components were added in succession with stirring: 1 g of Byk® 340 (polymeric fluoro surfactant, flow control and wetting assistant), 5 g of butyldiglycol acetate (solvent, film-forming assistant), 13 g of butylglycol acetate (solvent, film-forming assistant), 1.4 g of a mixture of dimethylethanolamine/water (1:1 based on weight) (base for adjusting the pH) and 3.1 g of distilled water. This was followed by stirring at 1000 rpm for 30 minutes. After overnight standing, the pH was checked and was adjusted where necessary with a mixture of dimethylethanolamine/water (1:1 based on weight), so that the pH was within the range from 8.2 to 8.5. This gave around 224 g of formulated dispersion component, from which the two-component coating composition was produced by addition of the isocyanate component (see below).

| | Monomodal = | Bimodal = | Fine | |
|---|---|---|---|---|
| Viscosity | dispersion P1 or | dispersion | dispersion | Coarse |
| mPas* | CB1 | P2:P3 (1:1) or B1 | P2 | dispersion P3 |
| Pure | 56 | 37 | 92 | 33 |
| dispersion | | | | |
| Formulated | 157 | 175 | 407 | 37 200** |
| component | | | | |

*unless otherwise stated, determined using Brookfield RVT viscometer with spindle 3 at 100 rpm, 23° C.
**determined using Brookfield RVT viscometer, spindle 7 at 50 rpm, 23° C.

Polyisocyanate Component

Polyisocyanate components used were as follows:
Bayhydur® 3100=hydrophilically modified aliphatic polyisocyanate from Bayer MaterialScience
Easaqua® X D 803=aliphatic polyisocyanate in solution (70% in 3-methoxy-n-butyl acetate) from Vencorex

The polyisocyanate components were introduced into the respective polyacrylic component by various methods:

Manual Stirred Incorporation

In this case, Bayhydur® 3100 was used as a 70 wt % solution in 3-methoxy-n-butyl acetate. Easaqua® X D 803 was used in the form as supplied. 30 seconds after mixing of the polyacrylate component with the polyisocyanate component, stirred incorporation took place by hand for 30 seconds with a wooden spatula. Thereafter the solids content was adjusted to 40% using distilled water.

Stirred Incorporation Using a Laboratory Stirrer (Dispermat®)

The polyisocyanate components in this case were used in the form as supplied. The dispersion was stirred at 500 rpm, and the isocyanate and a calculated amount of water (leading to a final solids content of 40%) were added over 2-3 minutes. The stirring speed was subsequently raised to 1000 rpm and stirring was continued for 5 minutes.

Amount of Polyisocyanate Component Used

Mixing took place in an “index” of 100, in other words such that within the coating material, hydroxyl groups and isocyanate groups are present in a stoichiometric ratio of 1:1.

Performance Testing

Viscosity

The viscosity was measured using a Brookfield RVT viscometer at room temperature with spindle 3 at 100 rpm.

Sand Drying

The coating films were knife-coated onto glass (180μ wet film thickness) and subjected directly to the sand test. The apparatus used for this test consists of a cylindrical hopper which moves over the coating film at a defined, constant velocity (1 cm/h=removal/time, i.e., the removal corresponds to a defined drying time), beginning at one end of the coating film. In the course of movement over the coating film, sand trickles onto the drying film. At the locations (=drying times) at which the coating surface has not yet completely dried, the film is still tacky and the sand remains adhering at these points. If, conversely, surface drying has concluded, the sand lying on the coating film at these points can simply be wiped off with a fine brush. The distance over which sand remains adhering to the coating surface corresponds to the time required by the coating material in order to form a tack-free surface.

Gloss

Coating films were knife-coated onto a Byk® Gloss Card (100μ wet film thickness). The gloss was measured in the black region of the Gloss Card, using a Byk-Gardner gloss/haze instrument.

Use of Bayhydur ® 3100 incorporated by laboratory stirrer

| | Monomodal | | Bimodal | |
|---|---|---|---|---|
| Polyacrylate component | 45 | g CB1 | 45 | g B1 |
| Polyisocyanate component | 6.2 g Bayhydur ® | | 6.2 g Bayhydur ® | |
| | 3100 | | 3100 | |
| Water (fully demineralized) | 9.4 | g | 9.4 | g |
| Viscosity | 62 | mPas | 45 | mPas |
| Film appearance | specks, clear | | few specks, clear | |
| Sand drying | 1.3 | h | 1.2 | h |

| | | |
|---|---|---|
| Gloss 20° | 73 | 72 |
| Gloss 60° | 88 | 87 |

Use of Bayhydur ® 3100 incorporated by manual stirring

| | Monomodal | | Bimodal | |
|---|---|---|---|---|
| Polyacrylate component | 45 | g CB1 | 45 | g B1 |
| Polyisocyanate component | 8.9 g Bayhydur ® | | 8.9 g Bayhydur ® | |
| | 3100 (70% in 3- | | 3100 (70% in 3- | |
| | methoxy-n-butyl | | methoxy-n-butyl | |
| | acetate) | | acetate) | |
| Water (fully demineralized) | 6.7 | g | 6.7 | g |
| Viscosity | 69 | mPas | 56 | mPas |
| Film appearance | cloudy, no specks | | cloudy, no specks | |
| Sand drying | 1.5 | h | 1 | h |

| | | |
|---|---|---|
| Gloss 20° | 1.5 | 2.7 |
| Gloss 60° | 14 | 21 |

Use of Easaqua ® X D 803 incorporated by manual stirring

| | Monomodal | | Bimodal | |
|---|---|---|---|---|
| Polyacrylate component | 45 | g CB1 | 45 | g B1 |
| Polyisocyanate component | 8.7 g Easaqua ® | | 8.7 g Easaqua ® | |
| | X D 803 | | X D 803 | |
| Water (fully demineralized) | 6.6 | g | 6.6 | g |
| Viscosity | 152 | mPas | 76 | mPas |
| Film appearance | numerous | | few specks, clear | |
| | specks, clear | | | |
| Sand drying | 1.3 | h | 1 | h |

| | | |
|---|---|---|
| Gloss 20° | 47 | 61 |
| Gloss 60° | 77 | 85 |

Use of Easaqua ® X D 803 incorporated by laboratory stirrer

| | Monomodal | | Bimodal | |
|---|---|---|---|---|
| Polyacrylate component | 45 | g CB1 | 45 | g B1 |
| Polyisocyanate component | 9.1 g Easaqua ® | | 9.11 g Easaqua ® | |
| | X D 803 | | X D 803 | |
| Water (fully demineralized) | 0.4 | g | 0.4 | g |
| Viscosity | 287 | mPas | 79 | mPas |

| | | |
|---|---|---|
| Film appearance | slightly | haze, minimal |
| | cloudy, specks | specks |
| Sand drying | n.d. | n.d. |
| Gloss 20° | n.d. | n.d. |
| Gloss 60° | n.d. | n.d.- |

n.d.: not determined

1. A two-component coating composition, comprising:
a water-dispersible polyisocyanate component, and
a polyacrylate component,
wherein the water-dispersible polyisocyanate component, comprises:
a polyisocyanate and
a reaction product of at least one polyisocyanate with at least one compound having at least one hydrophilic, non-isocyanate-reactive group and at least one isocyanate-reactive group and
wherein the polyacrylate component comprises:
an aqueous polymer dispersion comprising a hydroxyl-functional poly(meth)acrylate with bimodal or polymodal particle size distribution.

2. The two-component coating composition of claim 1,
wherein a difference between weight-average diameters of smaller and larger particles is at least 50 nm in the bimodal or polymodal particle size distribution.

3. The two-component coating composition of claim 1,
wherein a weight-average diameter of smaller particles is in the range from 20 to 300 nm and a weight-average diameter of larger particles is in the range from 150 to 700 nm in the bimodal or polymodal particle size distribution.

4. The two-component coating composition of claim 1,
wherein a weight ratio between large particles and small particles is in the range from 40:60 to 85:15 in the bimodal or polymodal particle size distribution.

5. The two-component coating composition of claim 1,
wherein solids content of the aqueous polymer dispersion is in the range from 35 to 70 wt %, based on the total weight.

6. The two-component coating composition of claim 1,
wherein a molar ratio of isocyanate groups in the water-dispersible polyisocyanate component to hydroxyl groups in the polyacrylate component is in the range from 0.2:1 to 5:1.

7. The two-component coating composition of claim 1,
wherein the hydroxy-functional poly(meth)acrylate has an OH number of 15 to 250 mg KOH/g.

8. A method for producing the two-component coating composition of claim 1, the method comprising:
mixing the polyisocyanate component and the polyacrylate component with one another.

9. A method of coating at least one material and/or at least one paint, the method comprising:
applying to the at least one material and the at least one paint the two-component coating composition of claim 1.

10. A method of coating at least one substrate, the method comprising:
applying to the at least one substrate the two-component coating composition of claim 1.
